(19) United States
(12) Patent Application Publication
(10) Pub. No.: US 2015/0190825 A1
(43) Pub. Date: Jul. 9, 2015

(54) HOSE END SPRAYER

(71) Applicant: Arminak & Associates, LLC, Azusa, CA (US)

(72) Inventors: Armin Arminak, Pasadena, CA (US); Gary M. Baughman, Fremont, IN (US)

(21) Appl. No.: 14/661,486

(22) Filed: Mar. 18, 2015

Related U.S. Application Data
(63) Continuation of application No. PCT/US2013/059442, filed on Sep. 12, 2013.
(60) Provisional application No. 61/702,908, filed on Sep. 19, 2012.
(60) Provisional application No. 61/713,775, filed on Oct. 15, 2012.

(51) Int. Cl. B05B 7/24; B05B 12/14

(52) U.S. Cl. CPC B05B 7/2443; B05B 12/1409

(57) ABSTRACT

A sprayer for dispensing a flowable product is disclosed and includes two (2) primary components including a housing and a valve insert. The housing includes a proximal end for connection to a supply of liquid and a separate attachment structure for connection to a product container, the product container including a flowable product which is intended to mix with the supply of liquid. A valve insert is assembled into the housing and the valve insert is movable in a rotary fashion relative to the housing in order to select one (1) of three (3) settings. The three (3) settings include an “OFF” position, a “light” product mix ratio setting and a “heavy” product mix ratio setting.

### CROSS REFERENCE TO RELATED APPLICATIONS

This application is a continuation of International Application No. PCT/US2013/059442 filed Sep. 12, 2013, which claims the benefit of U.S. Provisional Application No. 61/702,908 filed Sep. 19, 2012 and U.S. Provisional Application No. 61/713,775 filed Oct. 15, 2012, which are hereby incorporated by reference.

### BACKGROUND

Sprayers with a mechanism for attachment to a hose or similar liquid supply member have been constructed and arranged for connection to a container holding a supply of a product to be dispensed as part of a liquid flow stream. In some constructions the container includes a dip tube, or similar structure, which communicates with the sprayer. The mechanical construction of this general type or style of sprayer should be suitable for product dispensing, as a part of the liquid flow stream, assuming that the product and the selected liquid (for the initial or primary flow stream) have compatible chemistries and viscosities relative to the shapes, locations and sizes of the passages and apertures which are designed into the sprayer for handling the flow of product and the flow of supply liquid.

The methods of withdrawing product from the container may be grouped or categorized based on whether or not the primary supply liquid enters the container. If the primary supply liquid is not intended to fully enter the container, based on the overall construction and arrangement of the sprayer, then one way for the product to be withdrawn from the container is by means of a pressure difference or suction. A pressure difference which results in the product being withdrawn from the container may be based upon and referred to as either a suction force or a venturi effect. Fluid flow over or past an opening creates a suction force on that opening. When that opening is in flow communication with a liquid supply, such as an open end of a dip tube (otherwise positioned in the container), the suction force created by the passing flow maybe sufficient to actually pull product up out of the container, via the dip tube, and into the liquid supply. The sufficiency of the suction force depends on several factors including the volumetric flow rate of the supply liquid, the size of the dip tube opening, the distance the product needs to travel and the viscosity of the product which is contained within the container. The product which exits from the opening or outlet of the dip tube thereby mixes with the liquid flow stream which is flowing over that outlet.

When the sprayer design is based on some portion of the liquid actually entering the container, the dispensing of product from within the container is based in part on the volume or amount of liquid and the capacity of the container. At some point the container capacity is reached and as more liquid is attempted to be forced or introduced into the container, some portion of the contents of the container must exit. The portion which is dispensed may be predominantly product or may be a mixture of product and supply liquid.

There are at least two (2) design concerns with current sprayers. One (1) design concern is the complexity of the sprayer construction, including the number of primary component parts which are required and the design of those component parts in terms of their individual complexity. Another design concern is having an ability to select between two (2) different product concentration ratios, relative to the volume of the product to be delivered into the flow stream, per unit volume. A related design concern with the ability to select between two (2) different product concentration ratios is the need for structural shapes or geometries which contribute to the direction of the flow and to the creation of a suitable spray pattern for each ratio selected.

### SUMMARY

The disclosed sprayer provides a unique degree of simplicity in conjunction with a unique construction which enables the selective dispensing of two (2) different product ratios. The exemplary embodiment of the disclosed sprayer is based on connection to a hose and attachment to a container which holds a volume of the product which is to be dispensed by the sprayer as mixed with the supply liquid. Preferably, the product in the container is a liquid as the liquid flow stream from the supply is not intended to enter or fill the container as part of the dispensing methodology. More specifically, the hose is preferably a garden hose with a threaded fitting. The container configuration may be a refillable container for reuse or may be a pre-filled container for single use or may be a combination of the two (2), beginning as a pre-filled product, but being refillable.

The attachment of the sprayer to the container is arranged so that liquid product is drawn up into the body of the sprayer based on a pressure difference created by the volumetric flow rate of the supply liquid flow stream. In the exemplary embodiment which uses a garden hose, the supply liquid is water. As the water flows through the sprayer, a suction force is created inside of the sprayer and the suction force draws liquid product out of the container and mixes the liquid product with the supply liquid which is water. The product ratio choices are governed by the positioning of a flow panel with two (2) differently sized product flow apertures. The larger the aperture, the more product which is able to be withdrawn out of the container based on a per unit volume of the supply liquid. The initial comparative ratios are based on the actual ratio of the two (2) aperture sizes. The actual mixture proportion of product and water depends in part on other factors such as the volumetric flow rate of the water. However, unless the flow rate reaches some type of critical limit, generally speaking, the higher the volumetric flow rate, the higher the suction force and thus more product is withdrawn from the container. Within normal parameters and ranges, the selected mix ratio (either “light” or “heavy”) should remain fairly constant based on the structural specifics found within the sprayer. A feature which is related to the ability to select either one (1) of two (2) product ratio choices is the creation of two (2) shaped spray tracks, one (1) for each selection or choice so that a suitable flow direction and a suitable spray pattern is achieved for each selection.

The simplicity of the disclosed sprayer is found in a construction which uses two (2) primary unitary component parts which snap-fit together into a sprayer assembly. Additionally, two (2) secondary component parts are shown as part of the exemplary embodiment. One (1) secondary component part is an elastomeric pad and the other secondary component part is a sealing disk. These two (2) secondary component parts could be considered “optional” if much tighter tolerances were established and/or if some slight leakage could be tolerated. However, in order to utilize more nominal tolerances and to have an essentially leak-free structure, these two (2) secondary component parts would be used and are included in the exemplary embodiment.

Reference herein is made to the two (2) “primary” component parts since the elastomeric pad and/or sealing disk may optionally be added and even if included in the overall sprayer assembly, these parts would not be thought of as a “primary” component part based on what is often the elective nature of sealing gaskets, sealing pads and similar sealing components. With regard to the two (2) unitary, primary component parts, one (1) component part is the body or housing which provides the connection to the hose and provides the attachment to the container. The other component is a movable valve insert which includes the flow panel which defines the two (2) different product ratio apertures. In addition to the two (2) positions or settings where the two (2) different product ratios, the third position which may be selected is “OFF”. There is not a “water-only” mode or selection offered by the exemplary embodiment. As part of connecting the sprayer to a hose and to a product container, snap-in, threaded sleeves may be used. These are adapter or interface components and not considered parts of the referenced two (2) primary component parts which comprise the basic construction of the sprayer.

With the snap-fit construction and assembly for the valve insert, the orifice sizes defined by that valve insert can be easily changed. Another benefit of this specific style of construction is the ability to mix together the withdrawn product and the supply liquid, in this case water, in an open space within the housing before the mixture, as a spray, is dispensed by the sprayer. The selection of either a product ratio (“light” or “heavy”) or an “OFF” condition is made manually without incorporating any levers or linkages, thereby contributing to the simplicity of the overall construction and assembly.

In prior art constructions, when a “water-only” mode is desired, there needs to be a valve position or setting which allows the flow of water through the sprayer with the apertures for the product being closed. As shown by such prior art constructions, the desire to include a water-only mode creates a more complex structure. It is also seen that the mode selection is performed from the side of the sprayer, rather than from the top. In contrast to this type of prior art side control, the sprayer of the exemplary embodiment includes a “top” control allowing the selection or setting portion of the movable valve insert to be easily seen and easily accessed. As used herein, the “top” is a direction facing upwardly in the normal manner of use with the user holding a handle portion of the sprayer and directing the spray pattern forwardly.

In the exemplary embodiment which includes a “top” control structure, a lower flow surface is established. The existence of this lower flow surface or panel provides a structure for adding further shaping and contouring for creating a desired flow path and spray pattern for each product ratio selection and setting.

### BRIEF DESCRIPTION OF THE DRAWINGS

FIG. 1 is a side elevational view of a hose-end sprayer system, including a hose-end sprayer, according to the exemplary embodiment.

FIG. 2 is an exploded, side elevational view of the FIG. 1 hose-end sprayer system.

FIG. 3 is a side elevational view of a product container which comprises one component of the FIG. 1 hose-end sprayer system.

FIG. 4 is a perspective view of a unitary housing which comprises one component part of the FIG. 2 hose-end sprayer.

FIG. 5 is a top plan view of the FIG. 4 housing.

FIG. 6 is a side elevational view of the FIG. 4 housing.

FIG. 7 is a front elevational view of the FIG. 4 housing.

FIG. 8 is a side elevational view, in full section, of the FIG. 4 housing as viewed along cutting plane 8-8 in FIG. 5.

FIG. 9 is an angled side elevational view of the FIG. 4 housing as viewed along cutting plane 9-9 in FIG. 5.

FIG. 10 is a perspective view of a unitary valve insert which comprises one component part of the FIG. 2 hose-end sprayer.

FIG. 11 is a top plan view of the FIG. 10 valve insert.

FIG. 12 is a side elevational view of the FIG. 10 valve insert.

FIG. 13 is a rear elevational view of the FIG. 10 valve insert.

FIG. 14 is a bottom plan view of the FIG. 10 valve insert.

FIG. 15 is a side elevational view, in full section, of the FIG. 10 valve insert as viewed along cutting plane 15-15 in FIG. 11.

FIG. 16 is an angled side elevational view, in full section, of the FIG. 10 valve insert as viewed along cutting plane 16-16 in FIG. 11.

FIG. 17 is an angled side elevational view, in full section, of the FIG. 10 valve insert as viewed along cutting plane 17-17 in FIG. 11.

FIG. 18 is a front elevational view, in full section, of the FIG. 10 valve insert as viewed along cutting plane 18-18 in FIG. 11.

FIG. 19 is a top plan view of the FIG. 2 hose-end sprayer in an “off” position.

FIG. 20 is a perspective view of the FIG. 19 hose-end sprayer.

FIG. 21 is a front elevational view of the FIG. 19 hose-end sprayer.

FIG. 22 is a rear elevational view of the FIG. 19 hose-end sprayer.

FIG. 23 is a side elevational view, in full section, of the FIG. 19 hose-end sprayer as viewed along cutting plane 23-23 in FIG. 19.

FIG. 24 is a top plan view of the FIG. 2 hose-end sprayer in a “light” position.

FIG. 25 is a perspective view of the FIG. 24 hose-end sprayer.

FIG. 26 is a front elevational view of the FIG. 24 hose-end sprayer.

FIG. 27 is a rear elevational view of the FIG. 24 hose-end sprayer.

FIG. 28 is a side elevational view, in full section, of the FIG. 24 hose-end sprayer as viewed along cutting plane 28-28 in FIG. 24.

FIG. 29 is a top plan view of the FIG. 2 hose-end sprayer in a “heavy” position.

FIG. 30 is a perspective view of the FIG. 29 hose-end sprayer.

FIG. 31 is a front elevational view of the FIG. 29 hose-end sprayer.

FIG. 32 is a rear elevational view of the FIG. 29 hose-end sprayer.

FIG. 33 is a side elevational view, in full section, of the FIG. 29 hose-end sprayer as viewed along cutting plane 33-33 in FIG. 29.

FIG. 34 is a perspective view of a sealing disk which may be used as one part of the FIG. 2 hose-end sprayer.

FIG. 35 is a top plan view of the FIG. 34 sealing disk.

FIG. 36 is a side elevational view, in full section, of the FIG. 34 sealing disk as viewed along cutting plane 36-36 of FIG. 35.

FIG. 37 is a perspective view of an elastomeric pad which may be used as one part of the FIG. 2 hose-end sprayer.

FIG. 38 is a side elevational view of the FIG. 37 elastomeric pad.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

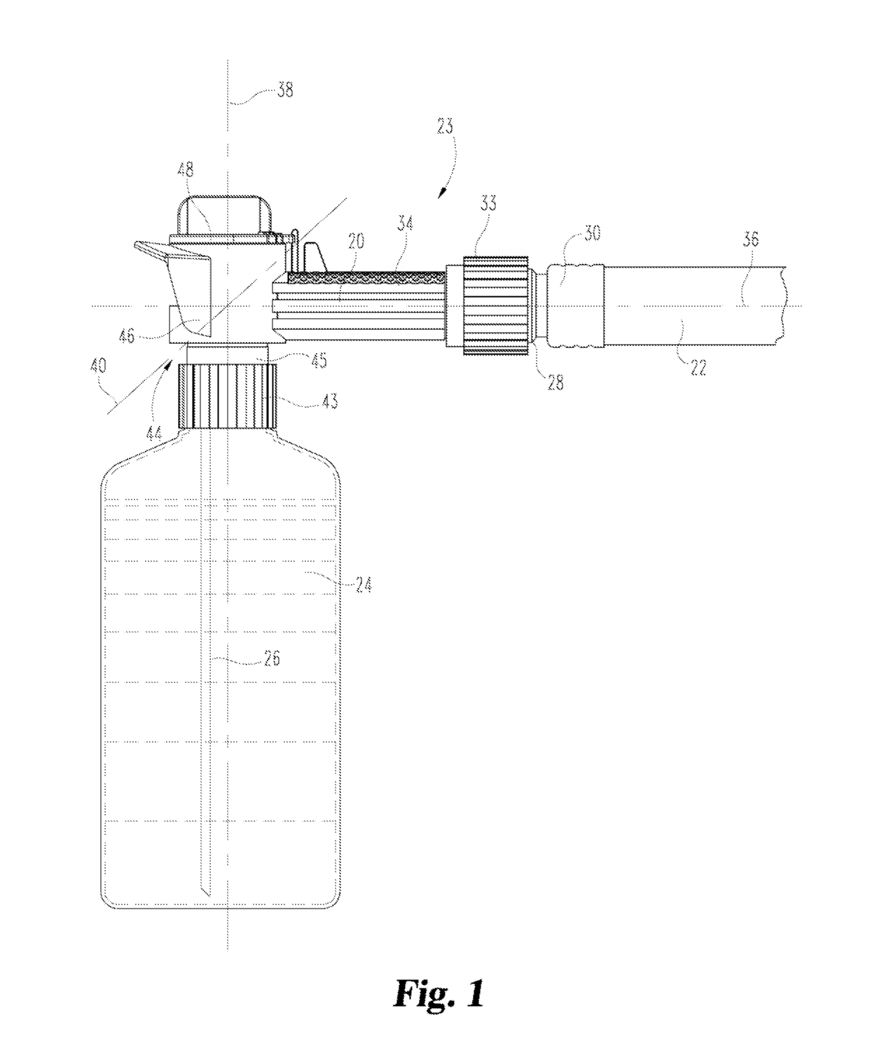

Referring to FIG. 1 there is illustrated a hose-end sprayer 20 according to an exemplary embodiment of the present disclosure. In the exemplary embodiment, sprayer 20 is connected to a hose 22 which provides a liquid supply flow stream into sprayer 20. In the exemplary embodiment, sprayer 20 is attached to a suitable receptacle for holding the product which is to be dispensed, referred to herein as product container 24. Product container 24 includes a supply of the selected product which is to be mixed with the supply liquid and dispensed in a spray pattern by the use of sprayer 20.

The combination of sprayer 20, hose 22 and container 24 comprises system 23. Dip tube 26 may be treated as a component part of the container 24, depending on how the dip tube 26 is supplied. The dip tube 26 may alternatively be treated as a component part of system 23 when the dip tube 26 is provided as a separate component part. The combination of sprayer 20 and container 24 comprises system 25. Included as a part of system 25 is dip tube 26. Dip tube 26 may be supplied separately or as part of either sprayer 20 or container 24. These three (3) components would typically be supplied for purchase without including the hose 22 as that part of system 23 is likely already available or would otherwise be provided separately. If not, then a hose such as a garden hose would need to be provided for connecting the supply liquid to the sprayer 20.

In the exemplary embodiment, the hose 22 is a garden hose with a suitable externally-threaded fitting 28 on end 30 for connecting the garden hose to the sprayer 20. Although a threaded fitting is one (1) option, another option is to use a quick-connect style which enables push-on and pull-off actions, typically without needing to twist or rotate any of the components. Handle 34 includes, as one (1) hose-connection option, an internally-threaded sleeve 33 which snaps into groove 42 and is able to rotate freely relative to handle 34. An elastomeric gasket is included to help seal the connection with hose fitting 28. Alternatively, groove 42 can be used as a part of a quick-connect style of fitting. The supply liquid, via hose 22, in the exemplary embodiment is water.

Although a garden hose and water have been selected as part of the exemplary embodiment, the construction of sprayer 20, as disclosed herein, is suitable for use with a variety of different liquids as the supply liquid which creates the flow stream into the sprayer 20. The sprayer 20 construction is also suitable for dispensing a variety of different products which can be provided in a variety of different container styles, shapes and sizes. One (1) property of the supply liquid which is important is viscosity. This property is also important for the product which is provided within the container. The incoming flow of supply liquid needs to have a volumetric flow rate which is sufficient to create a suction force which in turn is capable of pulling product up out of the container 24 and into the incoming flow stream of the supply liquid. The product viscosity needs to be within a range which allows the product to be pulled up from within the container 24. In the exemplary embodiment the container includes dip tube 26 as part of the means for drawing product up from the lower portion of container 24 and into the body of sprayer 20 where the product is able to flow through a suitable passageway into the incoming flow stream of supply liquid.

In order to assist with an understanding of the disclosed construction of sprayer 20 and its relationship to hose 22 and container 24, the following conventions will be used. First, the side elevational view of FIG. 1 has the sprayer 20 oriented in a normal, ready-for-use position. The right end of sprayer 20 where the hose 22 is connected represents the proximal end 32 of the sprayer 20 and the user is intended to be standing adjacent the proximal end 32 with one (1) hand grasping ahold of handle 34. The other hand of the user is then able to be used to select the desired spray setting or the “OFF” position. The “spray setting” refers to the product mix ratio, either “light” or “heavy”.

With sprayer 20 in the generally horizontal orientation of FIG. 1, the longitudinal axis represented by axis line 36 extends lengthwise from the left to the right in a generally horizontal direction where the left end represents the distal end and the right end represents the proximal end. This generally horizontal direction corresponds to the X-axis direction based on a Cartesian coordinate system and the X-axis direction corresponds with axis line 36.

The direction which is in (i.e. coplanar with) the plane of the paper and perpendicular to axis line 36 represents a vertical axis corresponding to axis line 38. Axis line 38 corresponds to the Y-axis direction based on the Cartesian coordinate system. The third axis which is represented by axis line 40 is into (i.e. perpendicular to) the plane of the paper and axis line 40 is perpendicular to axis line 36 and to axis line 38. This third axis represented by axis line 40 corresponds to the Z-axis of the Cartesian coordinate system.

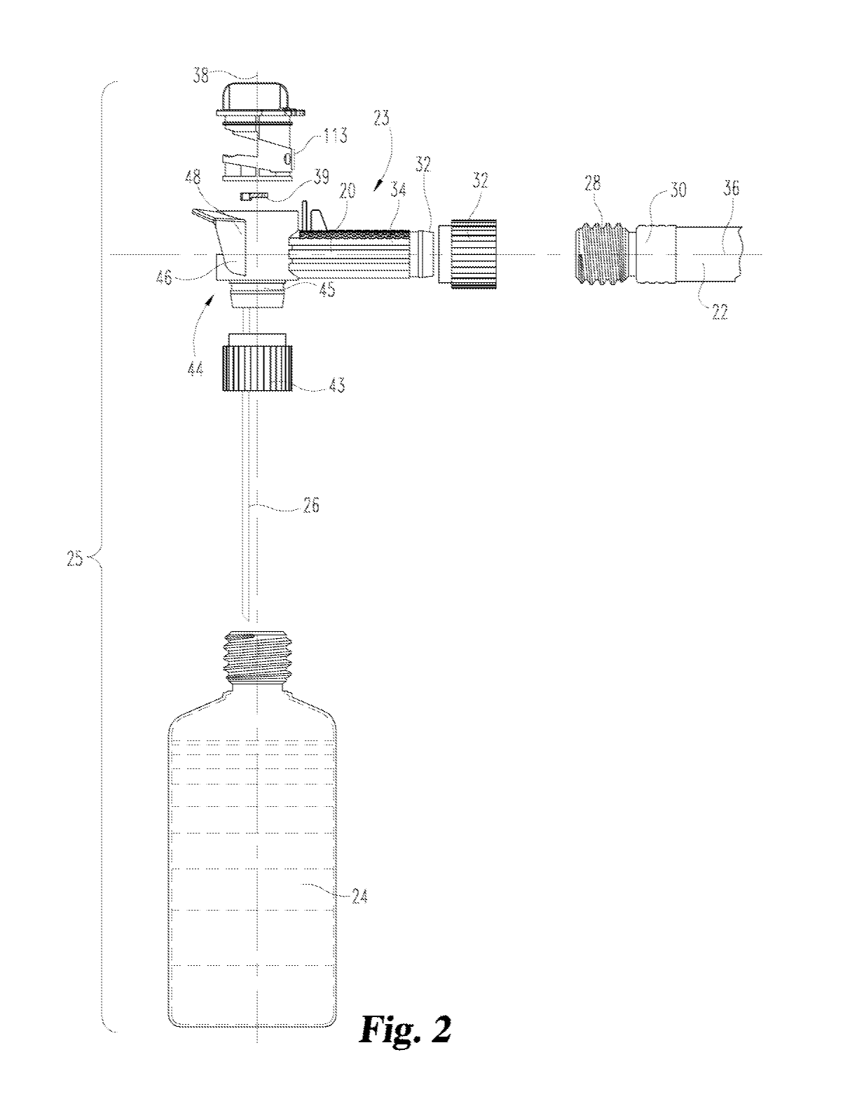

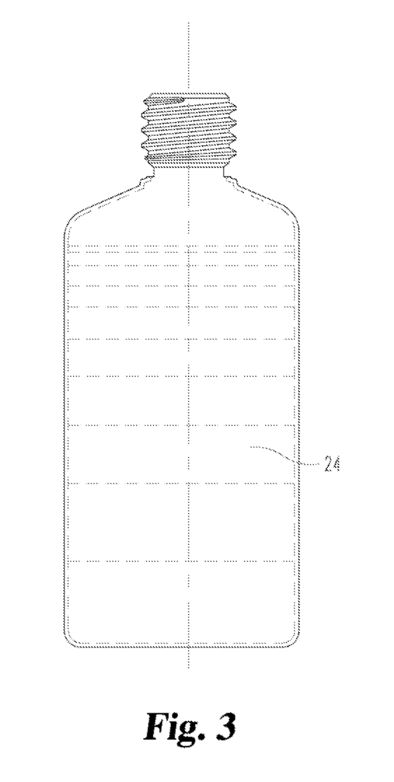

Referring now to FIG. 2, an exploded view of the FIG. 1 system 23 is illustrated. In this view, the sprayer 20 is illustrated without being connected to hose 22 and without attachment to the product container 24. The product container 24 is separately illustrated in FIG. 3. The dip tube 26 is included and may be provided as a part of sprayer 20, or as a part of container 24 or separately. The selected product has been placed in container 24 or the container may have come pre-filled with product.

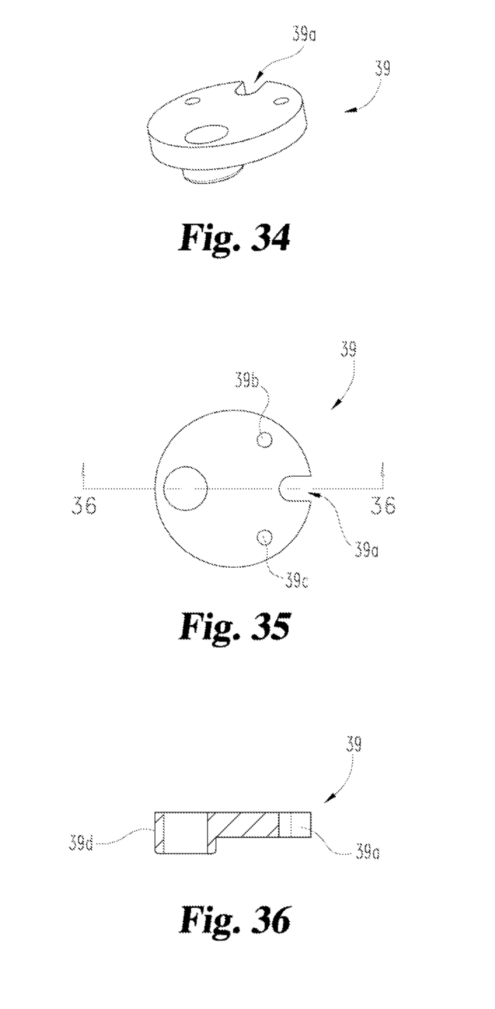

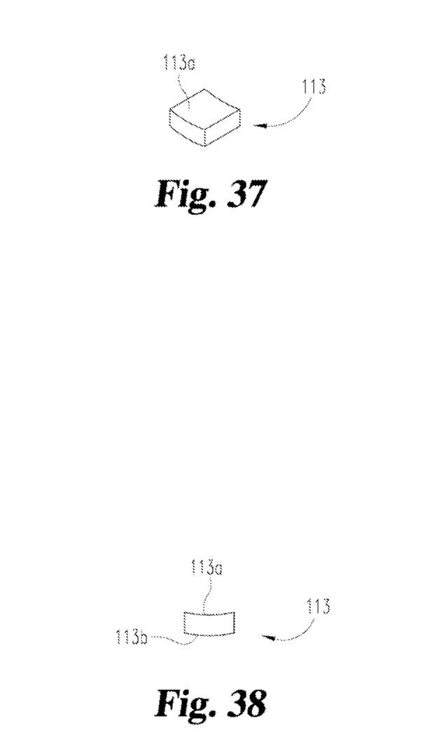

These additional items (dip tube and product) constitute part of the basis to refer to container 24 as a subassembly. Included as a part of this exemplary embodiment are sealing disk 39 and elastomeric pad 113, see FIGS. 34 and 37, respectively.

Sprayer 20 includes a connection groove 42 at the proximal end of handle 34. Groove 42 is used as part of the connection to fitting 28 of hose 22 with what is preferably a secure and leak-free connection. As noted above, the hose connection options include the use of threaded sleeve 33 or a quick-connect style of fitting. The distal end 44 includes a depending structure 45 for attachment to product container 24. The handle 34 extends from the proximal end 32 in the direction of the distal end 44 of housing 46. Structure 45 is configured similar to the proximal end of handle 34 with an annular connection groove 80. Also shown is an internally-threaded sleeve 43 which is similar to sleeve 33 and suitable for threaded connection to the threaded neck of container 24. As an alternative, groove 80 can be used as part of a quick-connect structure for connection to container 24.

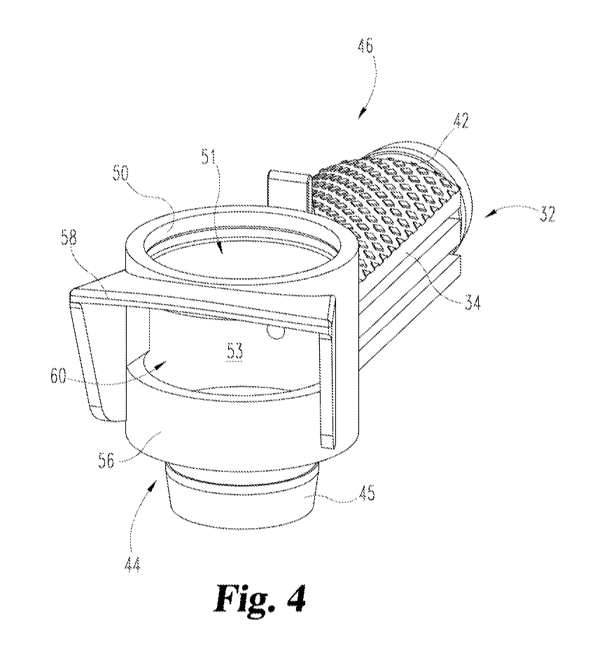

Sprayer 20 is a two-component part assembly including housing 46 and a snap-in valve insert 48. In the exemplary embodiment, the valve insert 48 has a snap-in assembly into a receiving portion 50 of the housing 46 (see FIG. 4). The receiving portion 50 is located at the distal end 44 of sprayer 20. Receiving portion 50 includes circular opening 51 and interior space 53. Valve insert 48 is constructed and arranged so as to be movable within and relative to housing 46 by a turning or rotating action, the axis of rotation being a line which is generally parallel with the Y-axis direction represented by axis line 38. Regardless of how the user may turn, tilt or rotate sprayer 20, this three-axis relationship remains the same relative to sprayer 20.

Rotation of valve insert 48 relative to housing 46 allows the user of sprayer 20 to select one (1) of three (3) settings. These three (3) settings include “OFF”, “light” and “heavy”. The “OFF” setting refers to a complete shut off of sprayer 20 where essentially no portion of the supply liquid, if the hose is “on” actually passes to the interior of sprayer 20. The “light” setting refers to the lower of the two (2) product mix ratios. The “heavy” setting refers to the higher of the two (2) product mix ratios which are available. There is no “water-only” mode incorporated into sprayer 20.

The phrase “product mix ratio” refers to the amount of product which is mixed into a specified volume of supply liquid, such as water from hose 22. One (1) way of specifying a mix ratio is by the use of “part”, such as one (1) part product to thirty (30) parts water. The actual product mix ratio is dependent in part on the size of a corresponding suction aperture, as will be described further herein.

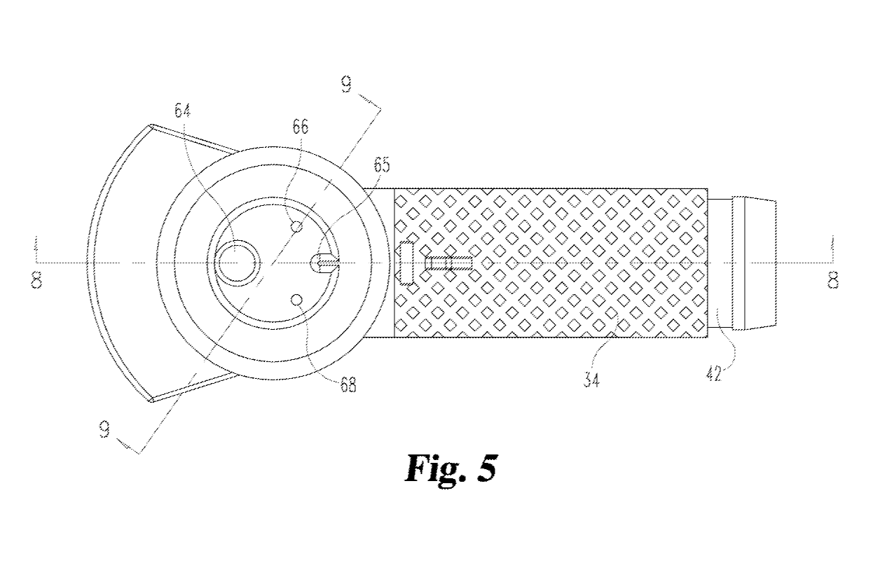

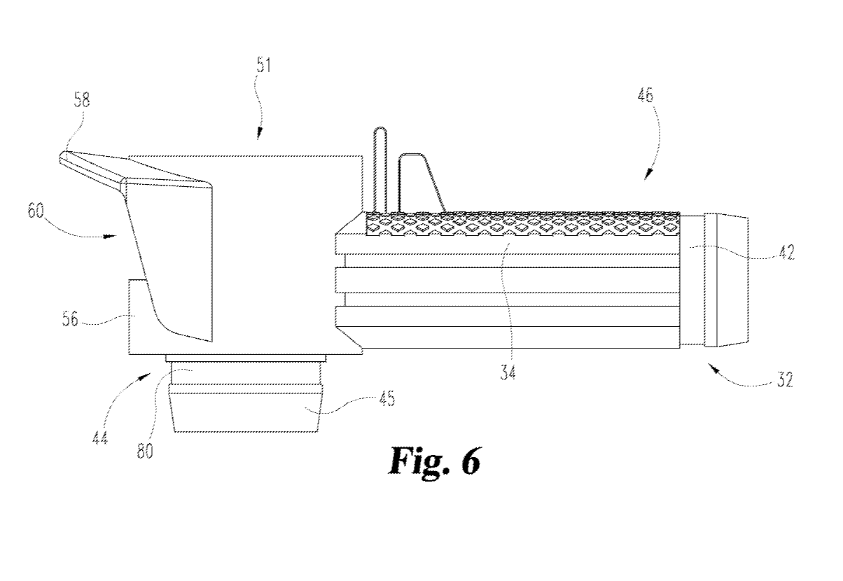

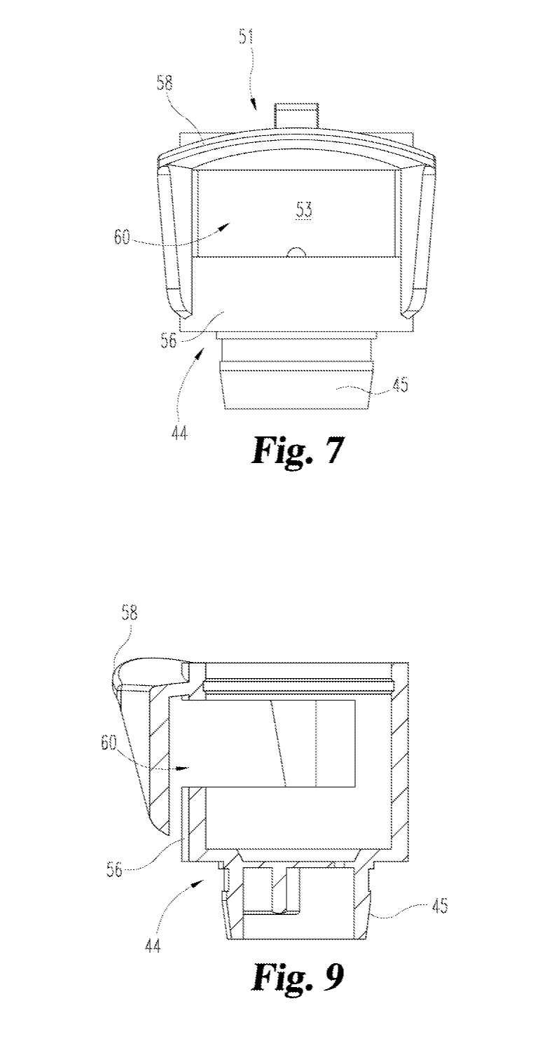

Referring now to FIGS. 4-9, additional structural details of housing 46 are illustrated. Housing 46 further includes a curved distal wall 56 and an overhanging cover or shroud 58 which cooperate at distal end 44 to define spray opening 60. Spray opening 60 is forwardly facing in the distal direction providing an outlet for the mixture of the supply liquid from hose 22 and product from container 24. This liquid mixture is dispensed as a spray due to the expansion of the higher velocity supply within the interior space 53 immediately upstream from opening 60.

With continued reference to FIGS. 4-9, housing 46 further includes a lower shelf 62 which defines product inlet 64 and two (2) spaced-apart vent openings 66 and 68. Alignment tab 65 interfits within slot 39a of sealing disk 39 for preventing turning or rotation of the sealing disk. Proximal dividing wall 70 in cooperation with distal wall 56 and lower shelf 62 define interior space 53. The axially (based on the Y-axis line 38) upper most portion 67 of dividing wall 70 is substantially cylindrical and portion 67 defines annular groove 69. Groove 69 is constructed and arranged to receive, via a snap-fit assembly, the outer lip 76 of a substantially cylindrical panel 77 of valve insert 48 for a snap-in capture of valve insert 48 by housing 46. The cylindrical form of both groove 69 and panel lip 76 allow the valve insert 48 to turn rotationally within and relative to housing 46.

Wall 70 defines the distal opening 71 of flow sleeve 72 and essentially serves as a dividing wall between handle 34 and receiving portion 50. Wall 70 and sleeve 72 are integrally molded as part of the single-piece unitary structure of housing 46. The proximal end of sleeve 72 defines flow inlet 73 for the receipt of supply liquid from hose 22. The incoming flow from hose 22 has an initial cross-sectional flow area generally corresponding to the size of the hollow interior 74 of handle 34. The only exit for this flow is to flow through flow sleeve 72 and out of handle 34 via distal opening 71. The reduction in cross-sectional flow area for essentially the same volume of supply liquid means an exit velocity from distal opening 71 which is increased over the flow velocity from hose 22. The designed exit velocity is based on a combination of the initial flow volume and the size of opening 71. The increase in flow velocity and the expansion of the flow stream within space 53 help to create a spray pattern for the mixture. The shaping of the interior of the housing 46 and valve insert 48 also help to define the spray pattern.

The hollow interior 74 of handle 34 is substantially cylindrical, though with a slight taper, and flow sleeve 72 is substantially cylindrical and substantially concentric with hollow interior 74. With the exception of distal opening 71, the wall interface between handle 34 and receiving portion 50 is closed. This closed condition ensures that all incoming flow of supply liquid from hose 22 into handle 34 exits via opening 71, except for any residual amount left at the time of shut down when the hose faucet is turned off (i.e. closed).

Dip tube sleeve 78 is substantially annular and is integral with lower shelf 62 and extends axially in a downward direction (the Y-axis line 38) from product inlet 64. Sleeve 78 defines a generally cylindrical hollow interior 79 which is sized and shaped to receive dip tube 26 with a press-in or push-in interference fit. The dip tube 26 extends from its fitting into sleeve 78 at one end to at or near the bottom or base of container 24. As described, as the flow of supply liquid indirectly passes over inlet 64 a pressure difference and the resulting suction force pulls product upwardly out of container 24 via dip tube 26. As will be described, the valve insert 48 is snapped into receiving portion 50 and the construction of valve insert 48 includes a movable inclined covering panel (flow aperture panel 114) with two (2) flow openings (122 and 124) and connecting passageways (120a and 120b). By lining up one (1) flow opening and its connecting passageway with inlet 64, the suction force pulls up a portion of the product which is within container 24 and that portion of product mixes with the flow of supply liquid, essentially the same flow which creates the suction force. The term “essentially” is used since there is a very slight time delay between the leading portion of supply liquid which creates the suction force and the trailing portion of supply liquid which receives product as a result of that suction force. In describing the flow of supply liquid over inlet 64, the term “indirectly” is used because panel 114 is physically between the flow of supply liquid and inlet 64.

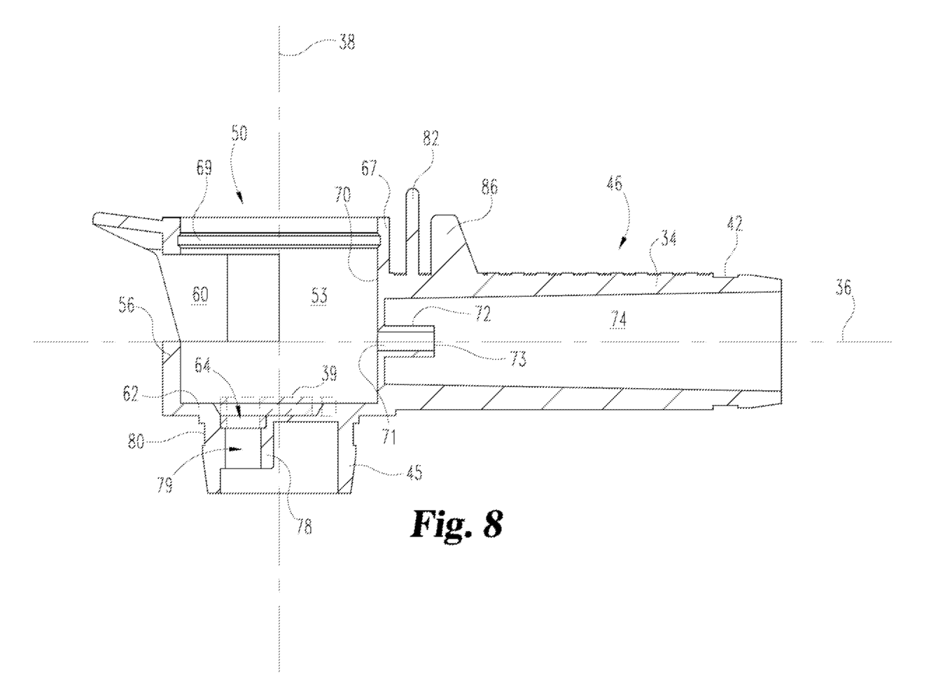

Depending structure 45 surrounds dip tube sleeve 78 and structure 45 is constructed and arranged with a snap-in connection groove 80 for use in attaching the product container 24 to the sprayer 20. Structure 45 is constructed and arranged similar to what is shown on the proximal end of handle 34 for connection to the hose 22. As noted above, the connection options for connecting the container 24 to the sprayer 20 include a threaded connection via sleeve 43 and a quick-connect style. If a quick-connect feature is used, this style of connection is also indicative of providing a quick-disconnect feature with a suitable pulling force. By pulling the container out of a connected arrangement with sprayer 20, or by unscrewing the container from the sprayer (i.e. from sleeve 43), a new pre-filled container can be connected or the removed container 24 can be re-filled with product and then re-connected to sprayer 20. In the FIG. 8 illustration the sealing disk 39 has been added in broken line form in order to establish its location relative to housing 46 and its optional nature. With further reference to FIGS. 34-36, sealing disk 39 includes holes 39b and 39c for alignment with vent openings 66 and 68, respectively. Generally cylindrical sleeve 39d is constructed and arranged to fit into the counterbore of dip tube sleeve 78, i.e. into product inlet 64.

The valve insert 48 is movable relative to housing 46 into one (1) of three (3) functioning positions or settings. One (1) setting is the “OFF” position which closes off the flow of supply liquid preventing any appreciable portion of that incoming flow from flowing through distal opening 71. A second setting is for a “light” product to water mix ratio which in relative terms means the lower of the two (2) possible product mix concentrations. This setting means less product in the water mixture as compared to the “heavy” setting which means more product in the water mixture.

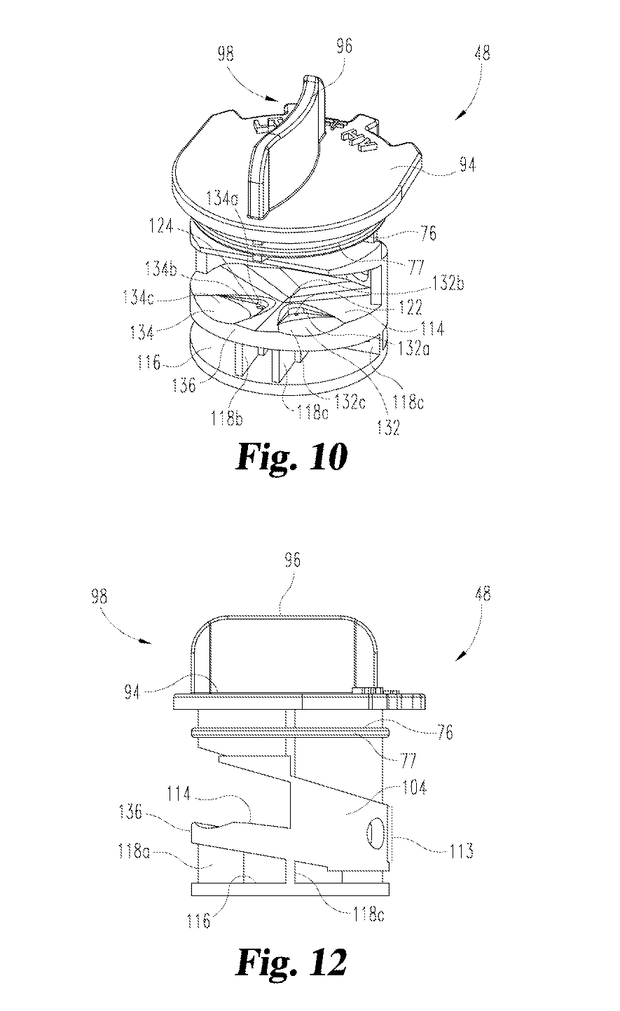

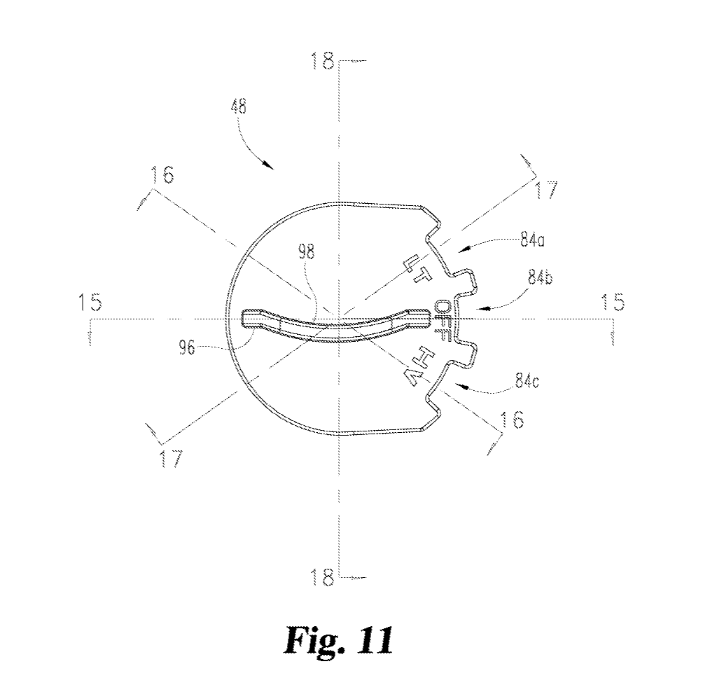

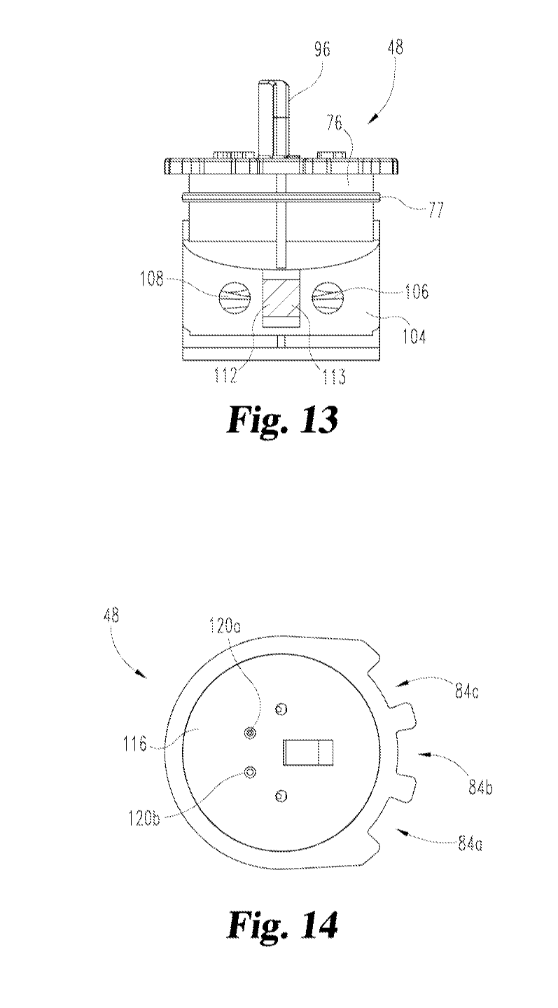

The handle 34 includes an upright or raised setting tab 82 which cooperates in a snap-in, indexing manner with a selected one (1) of the three (3) setting notches 84a, 84b and 84c defined by valve insert 48 (see FIGS. 10, 11, 13 and 14). Notch 84a corresponds to a “light” setting for the product mix ratio and this will be the spray output when insert 48 is turned such that notch 84a engages setting tab 82. Notch 84b corresponds to an “OFF” setting and notch 84c corresponds to a “heavy” setting for the product ratio. Handle 34 further includes an abutment post 86 to limit the amount or degree of “pull-back” on tab 82 in order to ease its movement into the selected notch.

Referring now to FIGS. 10-18, additional structural details of valve insert 48 are illustrated. Valve insert 48 further includes a substantially planar upper panel 94 which defines notches 84a, 84b and 84c. Integrally molded with upper panel 94 is knob extension 96 which is constructed and arranged to be used to turn or rotate valve insert 48 relative to and within housing 46 so as to select the desired setting, either “OFF”, “light” or “heavy”. Extension 96 is ergonomically shaped for easy gripping by a user's thumb and index finger. This shaping includes a center portion 98 which is curved.

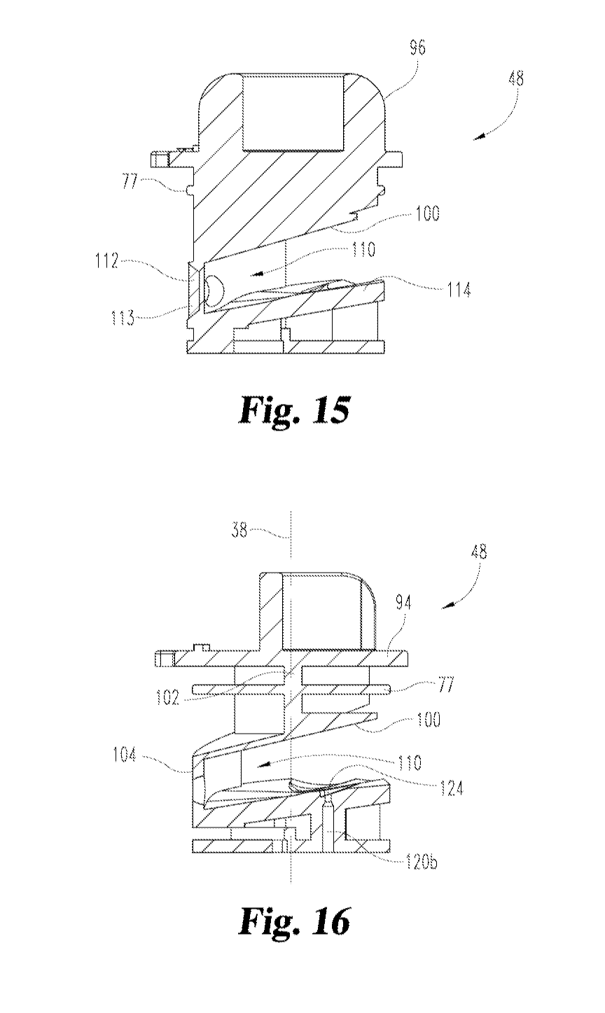

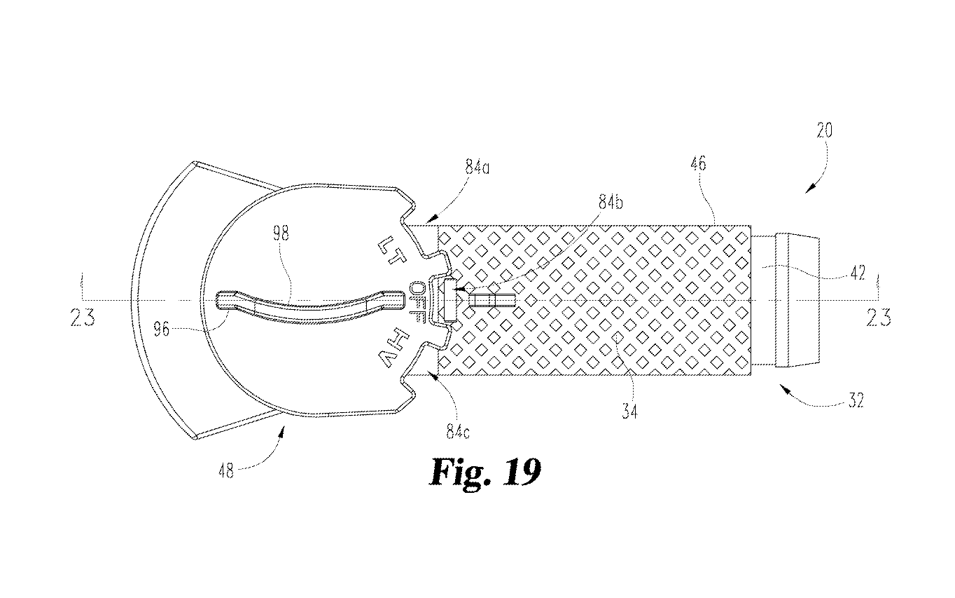

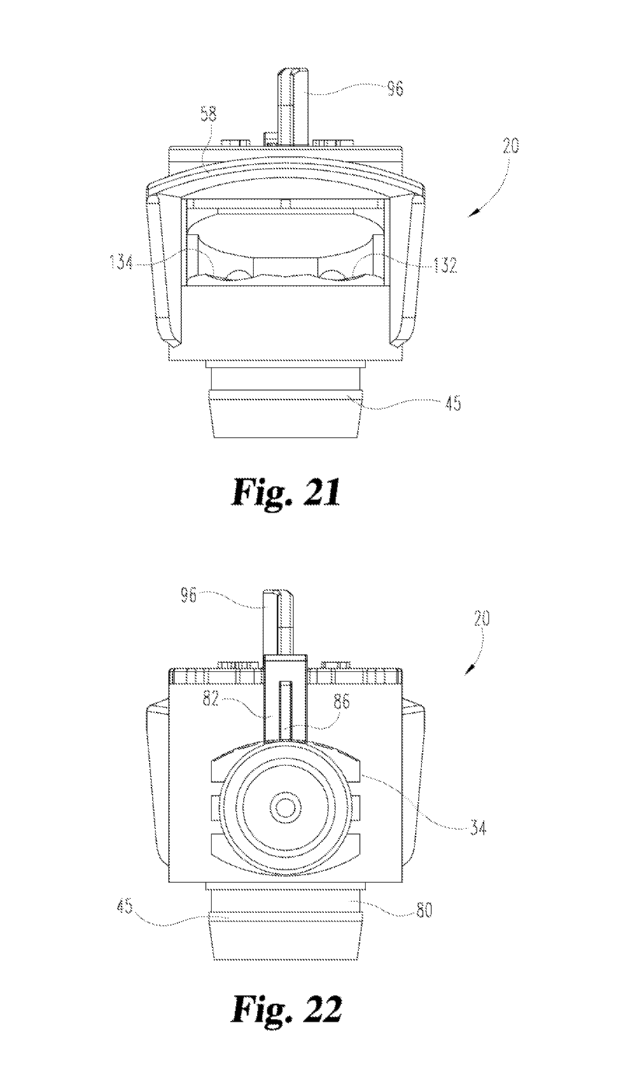

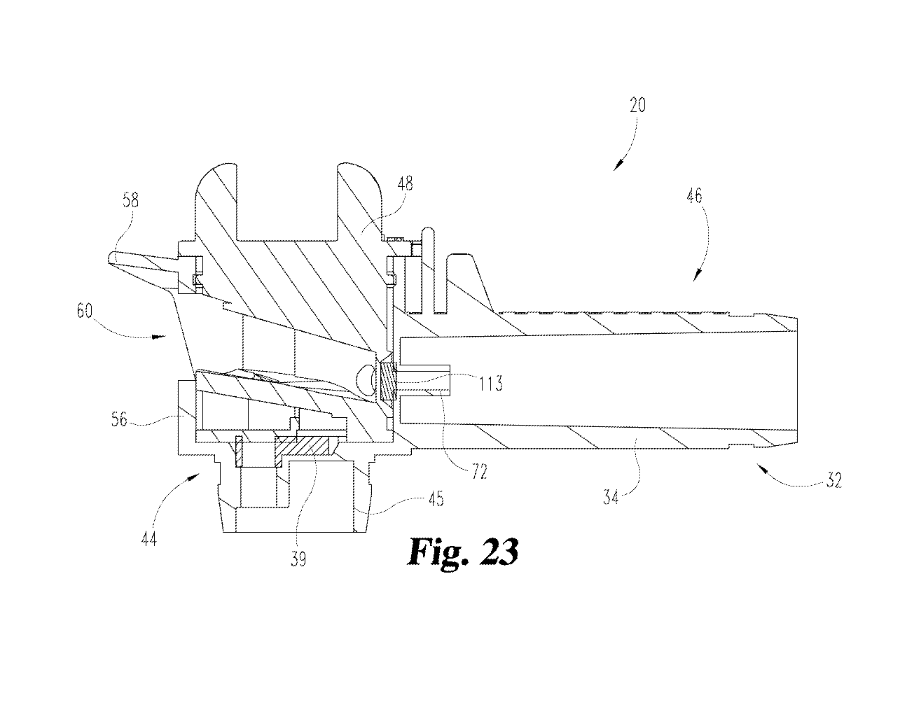

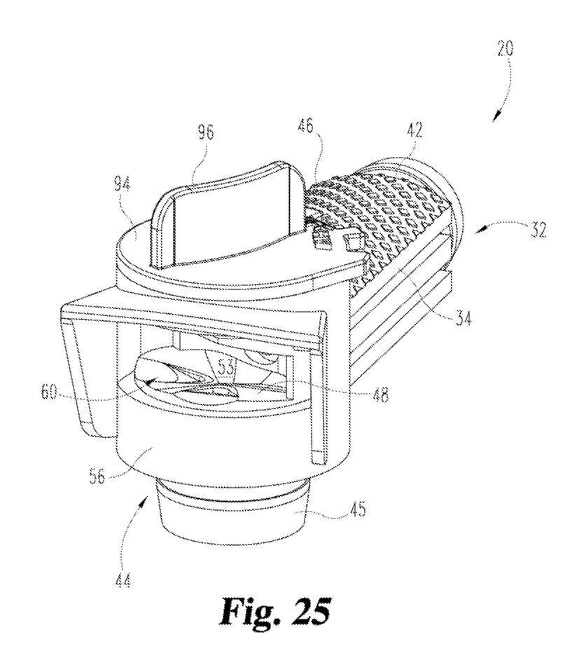

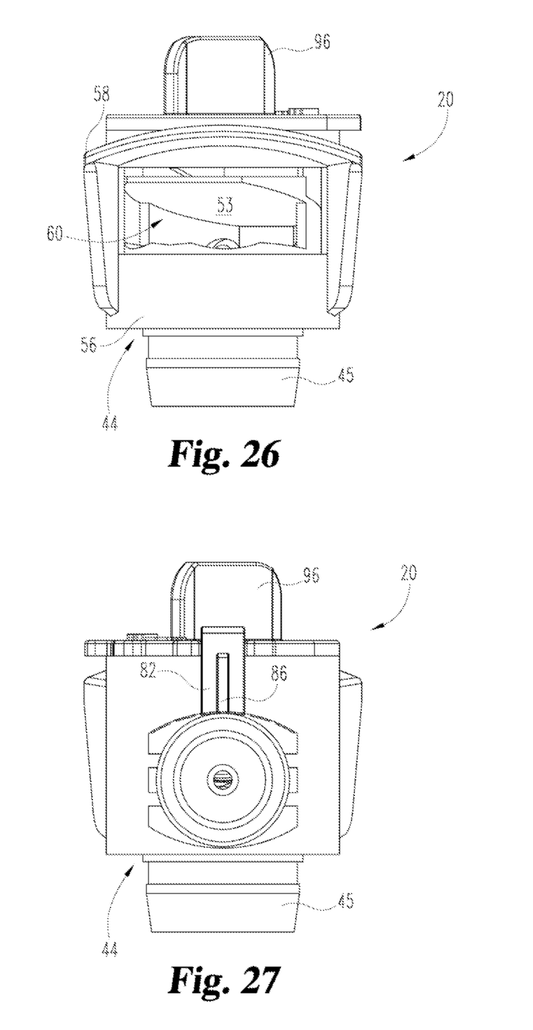

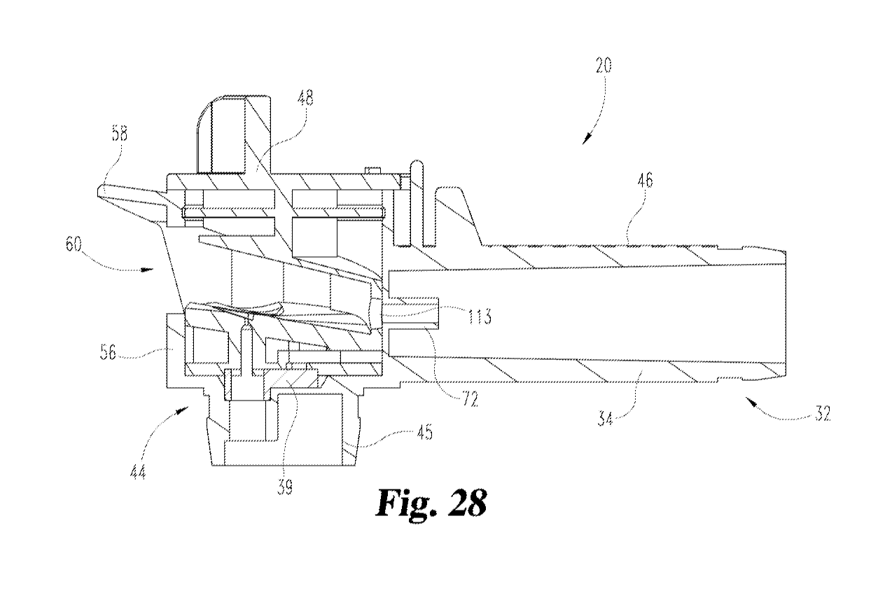

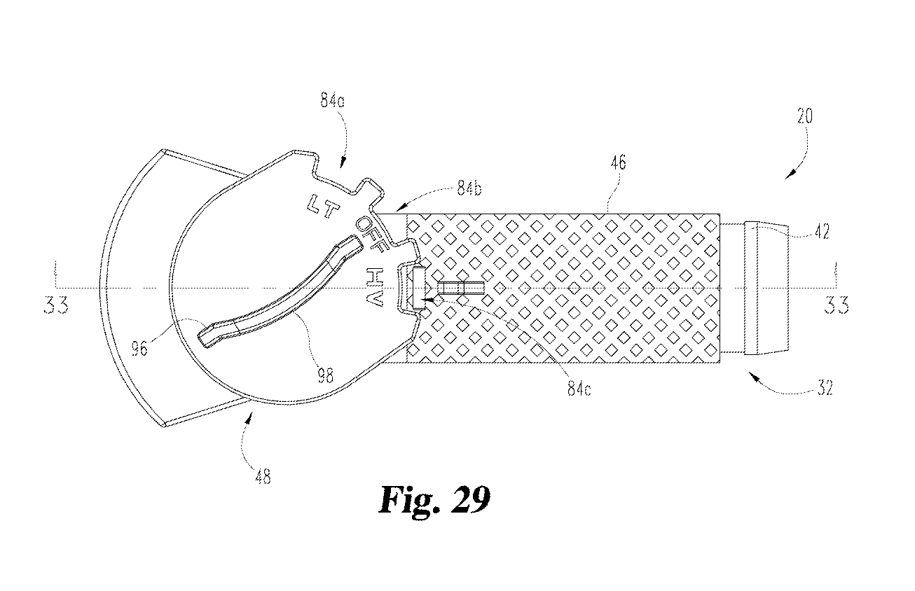

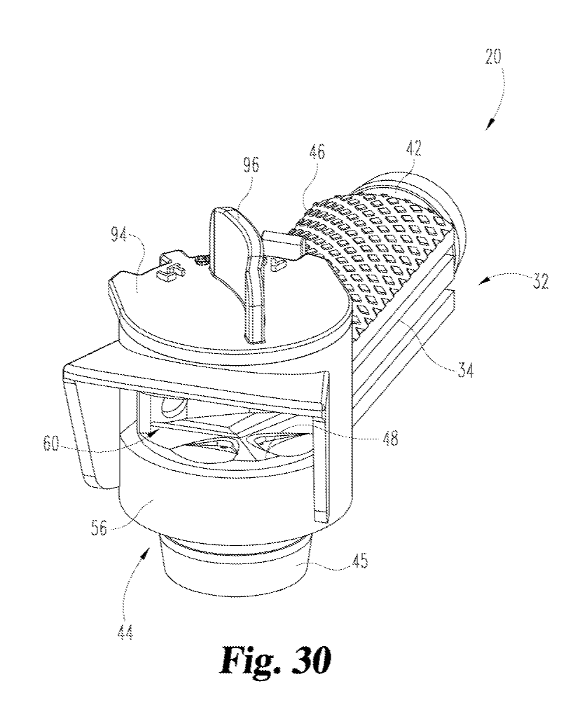

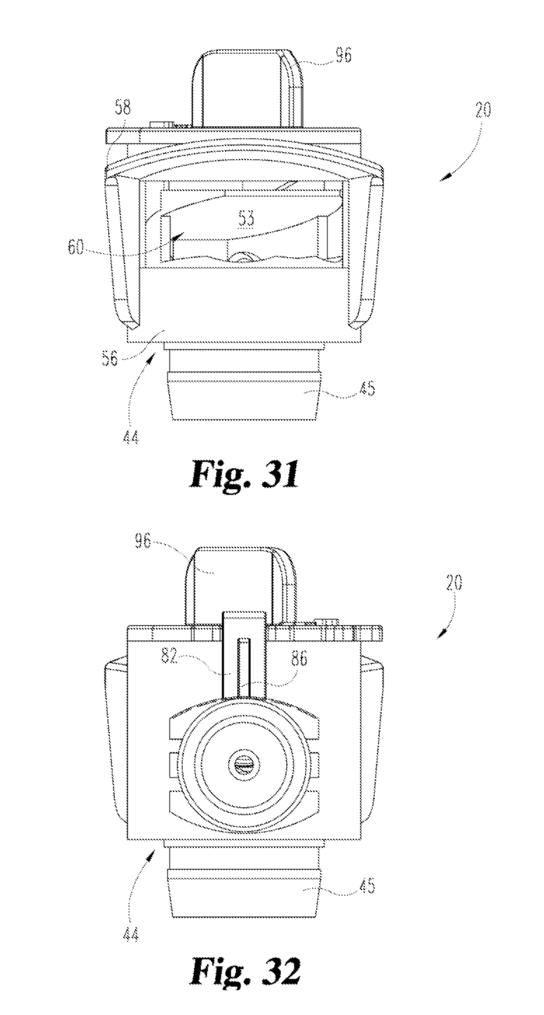

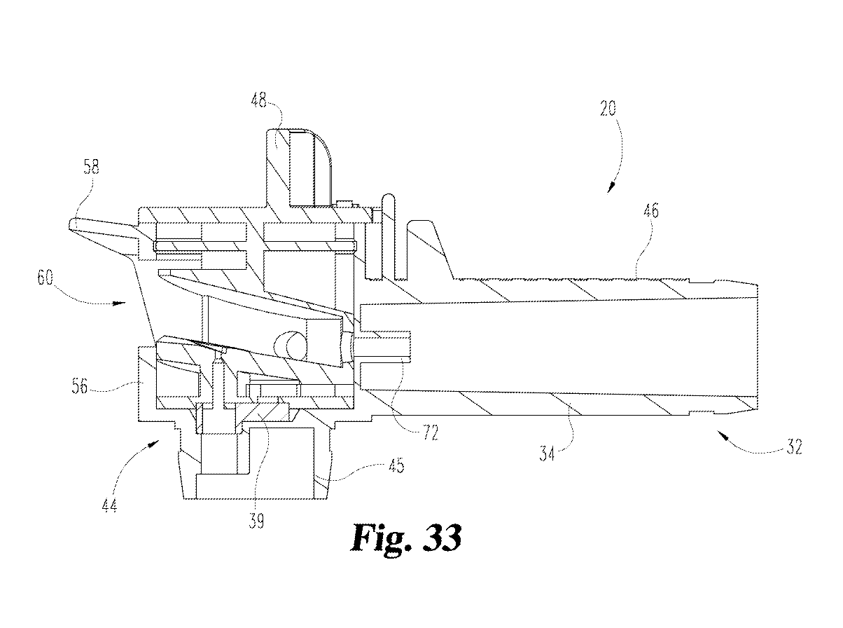

Moving downwardly in the axial direction of the Y-axis line 38, substantially cylindrical panel 77 is substantially planar and is constructed and arranged to be substantially parallel with upper panel 94. Axially below panel 76 is incline shelf 100. Panel 94, panel 77 and shelf 100 are integrally connected via partition 102 which extends in a substantially vertical direction which is substantially parallel with Y-axis line 38. Shelf 100 integrally extends into curved flow wall 104. The modifier of “flow” is used for wall 104 since this wall defines two (2) flow openings 106 and 108 for rotational alignment with distal opening 71. When valve insert 48 is rotated within housing 46 to the “light” setting position, opening 106 is aligned with opening 71 thereby permitting flow of the supply liquid into interior space 110 which is axially below incline shelf 100 (see FIGS. 15 and 16 and FIGS. 24-28). When valve insert 48 is rotated within housing 46 to the “heavy” setting position, opening 108 is aligned with opening 71 thereby permitting flow of the supply liquid into interior space 110 (see FIGS. 29-33). Wall 104 is closed between openings 106 and 108 for the “OFF” setting position. When valve insert 48 is rotated to the “OFF” position the closed portion 112 is aligned with opening 71 into a sealing condition or engagement so as to block and prevent any significant flow of supply liquid into the interior of sprayer 20, even if the hose faucet is still on or open (see FIGS. 19-23).

In order to facilitate a tight seal between closed wall portion 112 and the edge of opening 71, wall portion 112 is fitted with an elastomeric pad 113, see FIGS. 37 and 38. Pad 113 has a tight fit against wall 70 when the sprayer 20 is in either the “light” or “heavy” setting. The pad 113 is compressed in these positions. However, when valve insert 48 is turned to the “OFF” position, pad 113 is able to expand into opening 71 so as to establish a sealed interface. Pad 113 includes inner and outer curved surfaces 113a and 113b, respectively. These curved surfaces help pad 113 match the curvature of the two (2) curved surfaces which it contacts. Preferably, pad 113 is attached to valve insert 48 after the snap-in assembly of valve insert 48 into housing 46.

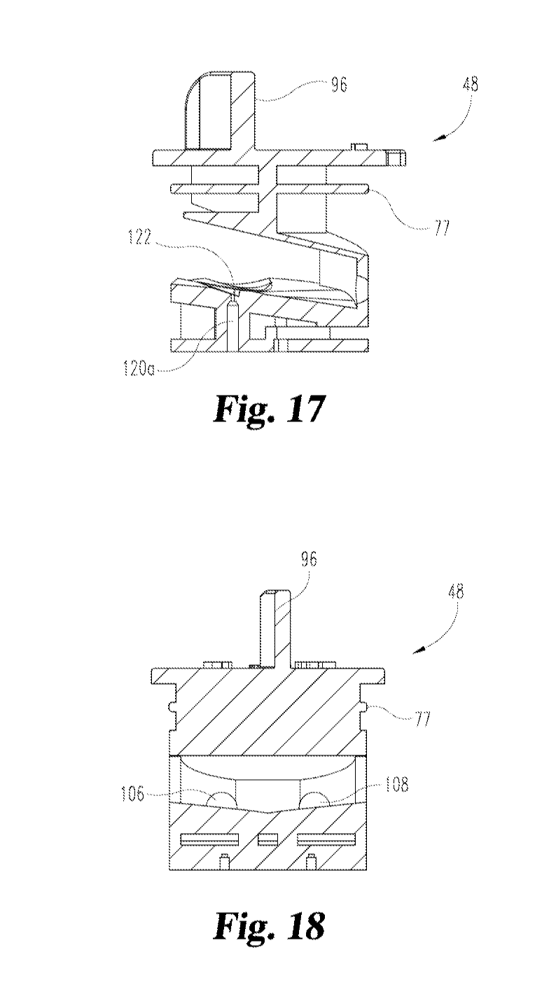

Axially below shelf 100 is incline flow aperture panel 114 which is integrally joined with wall 104. Shelf 100, wall 104 and panel 114 cooperatively define interior space 110. Lowermost panel 116 is integrally connected with panel 114 by upright portions 118a-c. Portions 118a and 118b are each constructed and arranged with a product flow passageway 120a and 120b, respectively, see FIGS. 16 and 17. Product flow passageway 120a intersects the upper surface of panel 114 and breaks out at aperture 122. Product flow passageway 120b intersects the upper surface of panel 114 and breaks out at aperture 124.

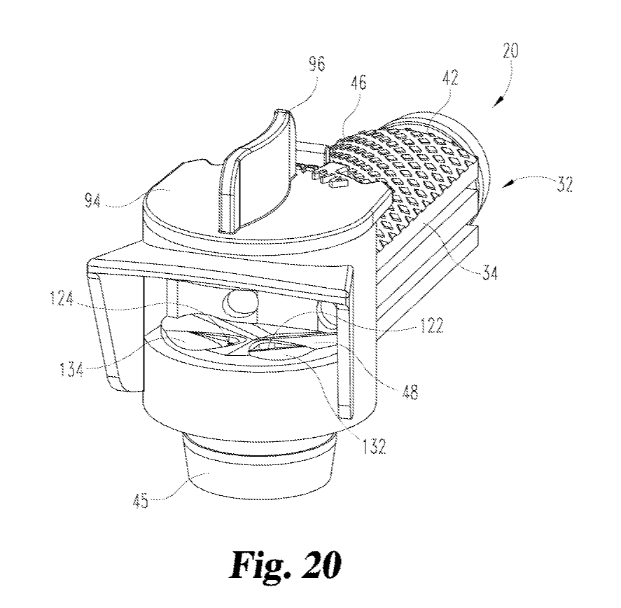

Panel 114 which helps to define flow apertures 122 and 124 as well as the corresponding flow passageways 120a and 120b, is shaped or contoured with two (2) spray tracks 132 and 134, see FIGS. 10 and 20. Spray track 132 is shaped around aperture 122 and extends forwardly to front edge 136 of panel 114. Spray track 134 is shaped around aperture 124 and extends forwardly to front edge 136 of panel 114. As shown by the drawings, each spray track 132 and 134 defines a recessed portion 132a and 134a, respectively, having a type of wedge shape with some curvature and with a first lower surface 132b and 134b, respectively, which is inclined upwardly and outwardly from the corresponding aperture. A second lower surface 132c and 134c, respectively, has a generally, part-parabolic shape and in combination with its corresponding first lower surface creates a generally, part-elliptical edge. Each spray track 132 and 134 is important in forwardly directing the flow and in creating a suitable spray pattern for the flow.

When the valve insert 48 is rotated within housing 46 to the “light” setting position, opening 106 is aligned with opening 71 and product flow passageway 120a is substantially aligned with product inlet 64. The flow of supply liquid from hose 22 flows in through flow sleeve 72 and opening 106 and across the upper, open aperture 122 of produce passageway 120a. The pressure difference, creating what is essentially a venturi effect, due to the flow velocity, pulls product upwardly out of container 24, up through passageway 120a and out via aperture 122 causing the product to mix with the stream of supply liquid before being dispensed as a spray.

When the valve insert 48 is rotated within housing 46 to the “heavy” setting position, opening 106 is aligned with opening 71 and product passageway 120b is substantially aligned with product inlet 64. The flow of supply liquid from hose 22 flows through sleeve 72 and opening 108 and across the upper, open aperture 124 of product passageway 120b. The pressure difference, creating what is essentially a venturi effect, due to the flow velocity, pulls product upwardly out of container 24, up through passageway 120b and out via aperture 124 causing the product to mix with the stream of supply liquid before being dispensed as a spray.

Product passageways 120a and 120b and the in corresponding apertures 122 and 124, respectively, are sized, in terms of their cross-sectional areas, such that the product flow area of aperture 124 is larger than the product flow area of aperture 122. The size ratio between these two (2) apertures determines, for the most part, the product concentration ratio between the “light” setting and the “heavy” setting. The actual product concentrations are also influenced by the volumetric flow rate of the supply liquid, but the concentration ratios are dictated by the size ratio of the two (2) product passageways.

The use herein of the phrase “substantially aligned” in reference to the alignment of any two (2) circular or cylindrical shapes, openings, sleeves, etc. means that the two (2) structures are generally concentric with each other with minimal mismatch. For the exemplary embodiment, noting that any mismatch reduces the cross-sectional flow area, the extent of the mismatch is less than 0.012 inches off of concentric.

Referring now to FIGS. 19-23, the snap-fit assembly of valve insert 48 into housing 46 is illustrated. The assembly details which are illustrated in FIGS. 19-23 include those structures and structural relationships which have been illustrated and described for housing 46 and for valve insert 48. As is illustrated in FIG. 19, the valve insert 48 is positioned in the “OFF” setting such that the supply liquid distal opening 71 is closed by the positioning of closed portion 112.

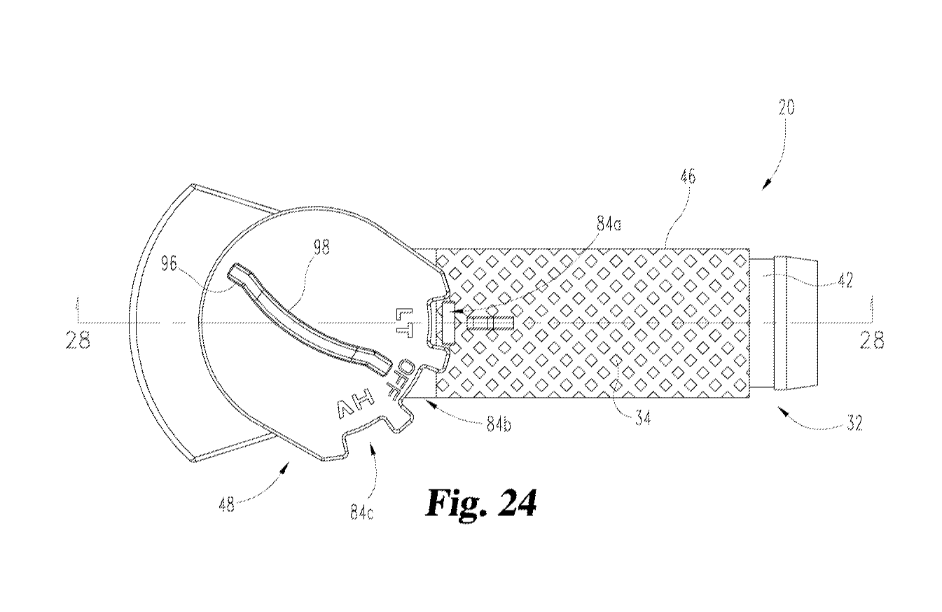

Referring now to FIGS. 24-28, the snap-fit assembly of valve insert 48 into housing 46 is illustrated. The assembly details which are illustrated in FIGS. 24-28 include those structures and structural relationships which have been illustrated and described for housing 46 and for valve insert 48. As is illustrated in FIG. 24, the valve insert 48 is positioned in the “light” setting such that the supply liquid distal opening 71 is open allowing the flow of supply liquid from hose 22.

Referring now to FIGS. 29-33, the snap-fit assembly of valve insert 48 into housing 46 is illustrated. The assembly details which are illustrated in FIGS. 29-33 include those structures and structural relationships which have been illustrated and described for housing 46 and for valve insert 48. As is illustrated in FIG. 29, the valve insert 48 is positioned in the “heavy” setting such that the supply liquid distal opening 71 is open and flow of supply liquid from hose 22 is permitted.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A sprayer for dispensing a flowable product comprising:
a housing including first means for connection to a supply of liquid,
second means for attachment to a product container and receiving means; and
a valve insert which is constructed and arranged for assembly into said receiving means for use in controlling a flow of product into a flow stream of said liquid, said valve insert having a relationship with respect to said housing which results in said valve insert being positionable in one of two different product mix settings.

2. The sprayer of claim 1 wherein said first means includes a quick-connect fitting for a hose.

3. The sprayer of claim 1 wherein said second means includes a quick-connect fitting for connection to said product container.

4. The sprayer of claim 1 wherein said receiving means includes an open space defined by portions of said housing.

5. The sprayer of claim 1 wherein said housing defines a product orifice for communication with said product container.

6. The sprayer of claim 1 wherein said valve insert includes a panel which defines a plurality of apertures.

7. The sprayer of claim 6 wherein said panel is shaped with a recessed spray track corresponding to one of the apertures of said plurality of apertures.

8. The sprayer of claim 1 wherein said plurality of apertures includes two apertures of different sizes for establishing different product mix ratios.

9. A fluid control device for mixing a first flowable media with a second flowable media and then dispensing a mixture of said first flowable media and said second flowable media, said fluid control device comprising:
a first member having first means for connection to a source of said first flowable media and second means for attachment to a source of said second flowable media; and
a second member assembled with said first member and being constructed and arranged to be movable relative to said first member for determining which of two proportional amounts of said second flowable media is to be withdrawn from said source of said second flowable media.

10. The fluid control device of claim 9 wherein said first means is a threaded sleeve.

11. The fluid control device of claim 9 wherein said second means is a threaded sleeve.

12. The fluid control device of claim 9 wherein said first member defines a flow opening for receiving said second flowable media.

13. The fluid control device of claim 12 wherein said second member defines two apertures, either one of which is selectively movable into alignment with said flow opening, wherein one aperture corresponds to one of said two proportional amounts and the other aperture corresponds to the other of said two proportional amounts.

14. The fluid control device of claim 13 wherein each aperture is positioned in a recessed spray track which is defined by said second member.

15. A fluid control device for mixing a first flowable media with a second flowable media and then dispensing a mixture of said flowable media and said second flowable media, said fluid control device comprising:
a first member having first means for connection to a source of said first flowable media and second means for attachment to a source of said second flowable media; and
a second member assembled with said first member and being constructed and arranged to be movable relative to said first member for selecting one of three settings, including an “OFF” setting and two different second flowable media ratio settings.

16. The fluid control device of claim 15 wherein said first means is a threaded sleeve.

17. The control device of claim 15 wherein said second means is a threaded sleeve.

18. The fluid control device of claim 15 wherein said first member defines a flow opening for receiving said second flowable media.

19. A fluid control device for mixing a first flowable media with a second flowable media and then dispensing a mixture of said flowable media and said second flowable media, said fluid control device comprising:
a first member having first means for connection to a source of said first flowable media and second means for attachment to a source of said second flowable media, said first member defining an aperture which is in flow communication with said source of said second flowable media; and
a second member assembled with said first member and being constructed and arranged to be movable relative to said first member, said second member defining a first orifice having a first lateral cross-section area which is movable into registration with said aperture and a second orifice having a second lateral cross-sectional area which is larger than said first lateral cross-sectional area, said second orifice being movable into registration with said aperture.

20. The fluid control device of claim 19 wherein said first means includes a quick-connect fitting for a hose.

21. The control device of claim 19 wherein said second means includes a quick-connect fitting.

22. The fluid control device of claim 19 wherein said first member and said second member are assembled by means of cooperating snap-fit constructions.

23. A mixing and dispensing device for use in mixing a first substance with a second substance and then dispensing a mixture of said first substance and said second substance, said mixing and dispensing device comprising:
a first member defining a first inlet for said first substance and a second inlet for said second substance; and
a second member assembled with said first member and being constructed and arranged to be movable relative to said first member, said second member being movable to select one of two proportionate settings for the amount of said second substance to be mixed with a unit flow volume of said first substance.

24. The mixing and dispensing device of claim 23 wherein said first member and said second member are assembled by means of cooperating snap-in constructions.

25. The mixing and dispensing device of claim 23 which further includes a sealing disk positioned between said first member and said second member.
